(19) United States
(12) Patent Application Publication
(10) Pub. No.: US 2014/0222189 A1
(43) Pub. Date: Aug. 7, 2014

(54) COMPUTING DEVICE AND METHOD FOR MEASURING PROBE OF COMPUTER NUMERICAL CONTROL MACHINE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHIH-KUANG CHANG, New Taipei (TW); XIN-YUAN WU, Shenzhen (CN); YI LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/097,231

(22) Filed: Dec. 4, 2013

(30) Foreign Application Priority Data
Feb. 4, 2013 (CN) 2013100424305

(51) Int. Cl. G05B 19/18

(52) U.S. Cl. CPC G05B 19/18
USPC 700/195

(57) ABSTRACT

A computing device is connected to a computer numerical control (CNC) machine, and an object positioned on a work table of the CNC machine includes one or more touch points. A probe from the CNC machine touches each touch point on an object and measures actual 3D mechanical coordinates of touch points. A 3D workpiece coordinates system is created according to the actual 3D mechanical coordinates of all touch points. Actual 3D workpiece coordinates of all touch points are calculated. Deviation values of each touch point are calculated between the actual 3D workpiece coordinates and theory 3D workpiece coordinates of each touch point. The deviation values are transformed to mechanical deviation values. The mechanical deviation values are compensated of each touch point for the CNC machine.

### BACKGROUND

1. Technical Field

Embodiments of the present disclosure relate to measuring technology, and particularly to a computing device and a method for computer numerical control (CNC) probe measurement.

2. Description of Related Art

Computer numerical control (CNC) machines produce products and measure sizes of the products to adjust CNC process programs. However, if Z-direction parts of the products are covered, the sizes of the products cannot be precisely measured.

### BRIEF DESCRIPTION OF THE DRAWINGS

FIG. 1 is a block diagram of one embodiment of an application environment of a computing device.

FIG. 2 is a block diagram of one embodiment of function modules of a probe measurement system in the computing device of FIG. 1.

FIG. 3 illustrates a flowchart of one embodiment of a method for measuring a probe of a CNC machine using the computing device of FIG. 1.

FIG. 4 is a schematic diagram illustrating moving the probe of the CNC machine to measure a touch point of an object.

FIG. 5 illustrates a flowchart of one embodiment of step S13 of FIG. 3.

FIG. 6 is a schematic diagram of an X-axis and a Y-axis of a three-dimension workpiece coordinates system.

FIG. 7 illustrates a flowchart of one embodiment of step S14 of FIG. 3.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

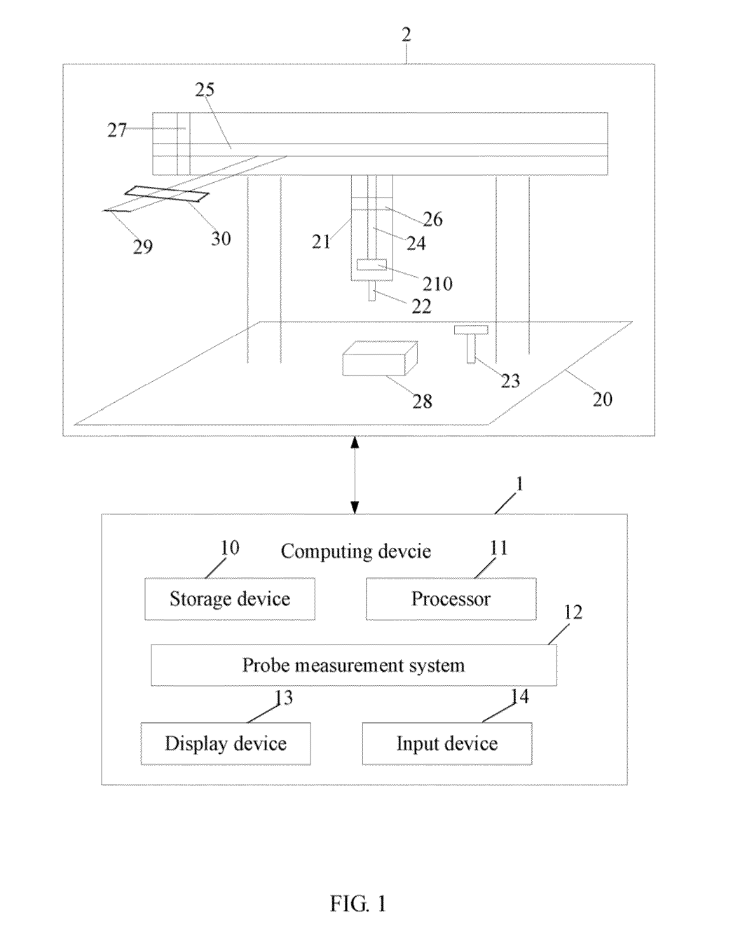

FIG. 1 is a block diagram of one embodiment of an application environment of a computing device 1. The computing device 1 is connected to a computer numerical control (CNC) machine 2. In one embodiment, the computing device 1 includes a storage device 10, a processor 11, and a probe measurement system 12 (hereinafter “the system 12”). The computing device 1 may further include a display device 13 and an input device 14, or the computing device 1 may be electronically connected to a display device 13 and an input device 14.

As shown in FIG. 1, the CNC machine 2 includes a CNC work table 20, a CNC main spindle 21, a probe 22, a module change rack (MCR) 23, a Z-axis optical ruler 24, an X-axis optical ruler 25, a Z-axis linear motor 26, and an X-axis linear motor 27. The CNC machine 2 may further include a Y-axis optical ruler 29, a Y-axis linear motor 30, and other clamping fixtures. The MCR 23 is used to place one or more probes 22.

A three-dimensional (3D) object 28 is positioned on the CNC work table 20. The system 12 is used to control the CNC machine 2 to measure size of the object 28. According to an object type of the object 28, the CNC main spindle 21 automatically obtains a probe 22 from the MCR 23 by a chuck 210 to measure the object 28. For example, the object type may be a cuboid, or a cube, or another type 3D object. Positions of the probes 22 in the MCR 23 can be replaced by cutting tools which are used to cut the object 28. Each probe 22 includes a force sensing element which is on a head of the probe 22, and the force sensing element senses whether the probe 22 approaches the object 28. The probe 22 may be cylindrical probes, spherical probes, or star probes. When Z-direction parts of the object 28 are covered, a star probe can be selected. When a measured surface of the object 28 is a slope, a cylindrical probe can be selected. When the measured surface is smooth and a high measurement precision is required, a star probe can be selected.

In one embodiment, the Z-axis optical ruler 24 is positioned on the CNC main spindle 21, the X-axis optical ruler 25 is parallel to the CNC work table 20 and perpendicular to the Z-axis optical ruler 24, and the Y-axis optical ruler 29 is perpendicular to the Z-axis optical ruler 24 and the X-axis optical ruler 25. The X-axis optical ruler 25, the Y-axis optical ruler 29 and the Z-axis optical ruler 24 are positioned and calibrated to form a 3D mechanical coordinates system, and used to measure mechanical coordinates X, Y, Z of a target point in the 3D mechanical coordinates system. The CNC machine 2 has three linear motors that drive the CNC main spindle 21 to move, and each optical rule corresponds to a linear motor. For example, the X-axis optical ruler 25 corresponds to the X-axis linear motor 27, the Y-axis optical ruler 29 corresponds to the Y-axis linear motor 30.

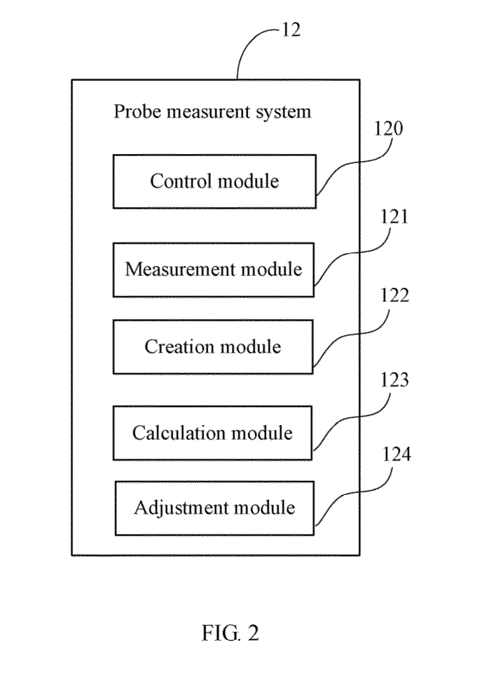

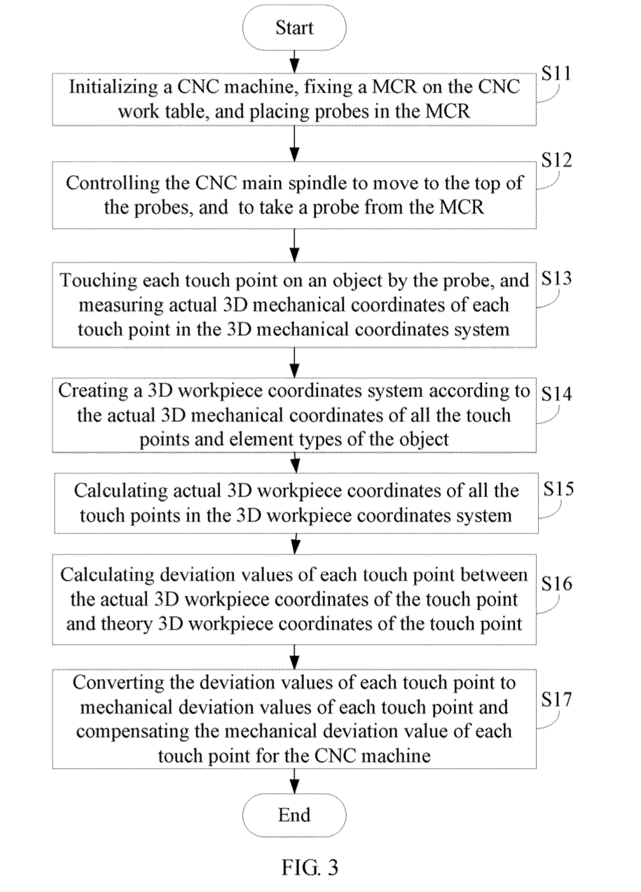

FIG. 2 is a block diagram of one embodiment of function modules of the system 12. In one embodiment, the system 12 may include a control module 120, a measurement module 121, a creation module 122, a calculation module 123, and an adjustment module 124. The function modules 120-124 may include computerized codes in the form of one or more programs, which are stored in the storage device 10. The processor 11 executes the computerized codes, to provide functions of the function modules 120-124. A detailed description of the function modules 120-124 is given in reference to FIG. 3.

FIG. 3 illustrates a flowchart of one embodiment of a method of the probe measurement using the computing device 1 of FIG. 1. Depending on the embodiment, additional steps may be added, others removed, and the ordering of the steps may be changed.

In step S11, the CNC machine 2 is initialized, the MCR 23 is fixed on the CNC work table 20, and the one or more probes 22 are placed in the MCR 23.

In step S12, the control module 120 controls the CNC main spindle 21 to move to the top of the MCR 23 and to take a probe 22 from the MCR 23 to measure the object 28. The object 28 includes one or more touch points. In one embodiment, when the CNC main spindle 21 takes the probe 22 by the chuck 210, the controlling module records 3D mechanical coordinates of the CNC main spindle 21 and a drawing force of the chuck 210. According to the recorded coordinates and the recorded drawing force, the control module 120 may further control the CNC main spindle 2 to automatically replace the probe 22 with another probe 22. The another probe 22 is in the MCR 23.

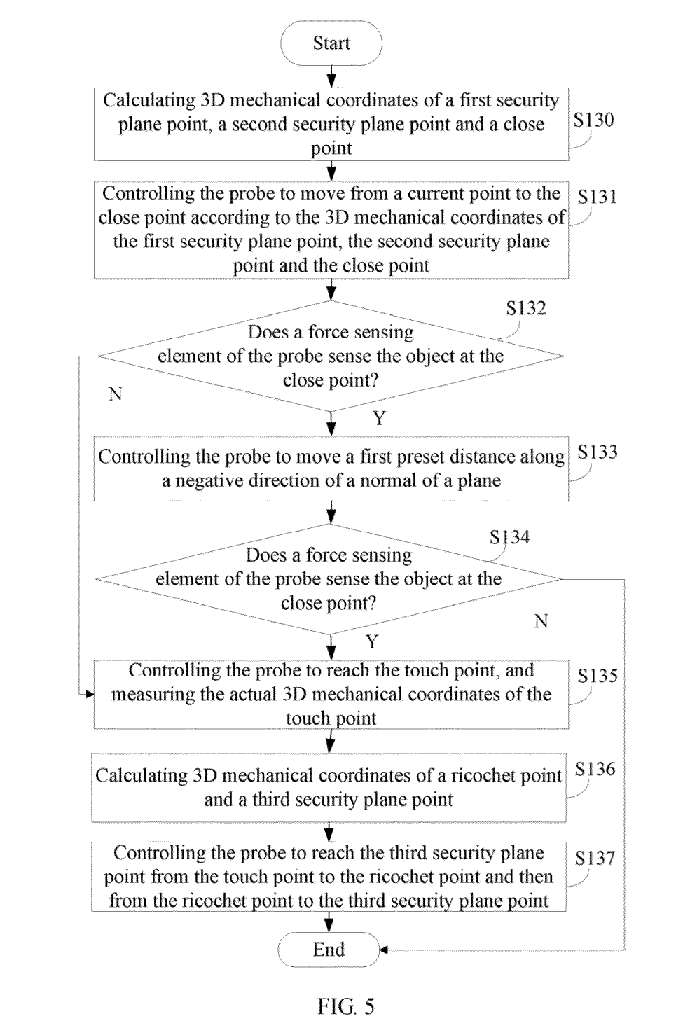

In step S13, the measurement module 121 touches each touch point on the object 28 by the probe 22, and measures actual 3D mechanical coordinates of each touch point in the 3D mechanical coordinates system. The touch points are measured target points on the object 28. As mentioned above, the 3D mechanical coordinates system is formed by the X-axis optical ruler 25, the Y-axis optical ruler 29 and the Z-axis optical ruler 24. In the 3D mechanical coordinates system, each touch point has theory three dimension mechanical coordinates. The step S13 is described in detail in FIG. 5.

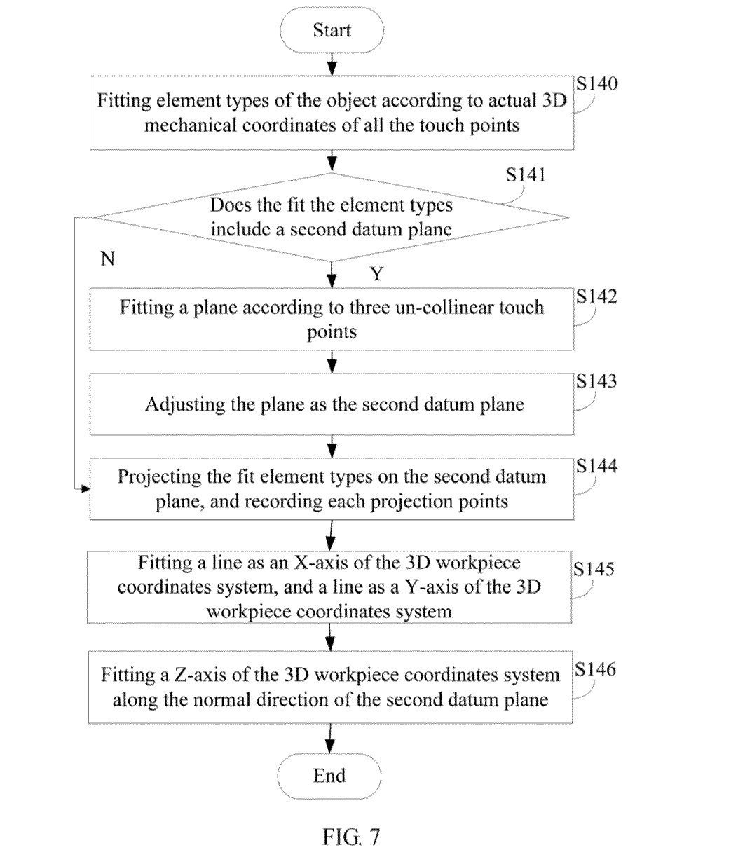

In step S14, the creation module 122 creates a 3D workpiece coordinates system according to the actual 3D mechanical coordinates of all the touch points and element types of the object 28 selected by the user. The element types may include a line, a plane, a circle, an arc, an ellipse, and a sphere. The element types are selected according to the object 28. The step S14 is described in detail in FIG. 7.

In step S15, the calculation module 123 calculates actual 3D workpiece coordinates of all the touch points in the 3D workpiece coordinates system. In one embodiment, the actual 3D workpiece coordinates of a touch point are distances between the touch point and an X-axis, a Y-axis, and a Z-axis of the 3D workpiece coordinates system.

In step S16, the calculation module 123 calculates deviation values of each touch point between the actual 3D workpiece coordinates of each touch point and theory 3D workpiece coordinates of each touch point in the 3D workpiece coordinates system. The theory 3D mechanical coordinates of each touch point is converted into the theory 3D workpiece coordinates of each touch point according to a conversion rule (e.g. conversion matrix) between the theory 3D mechanical coordinates system and the theory 3D workpiece coordinates system.

In step S17, the adjustment module 124 converts the deviation values of each touch point in the 3D workpiece coordinates system into mechanical deviation values of each touch point in the 3D mechanical coordinates system, and compensates the mechanical deviation value of each touch point for the CNC machine 2. In one embodiment, according to the mechanical deviation values of each touch point, a deviation of a processing route of the CNC machine 2 can be obtained. According to the deviation of the processing route, a CNC process programs of the CNC machine 2 can be adjusted.

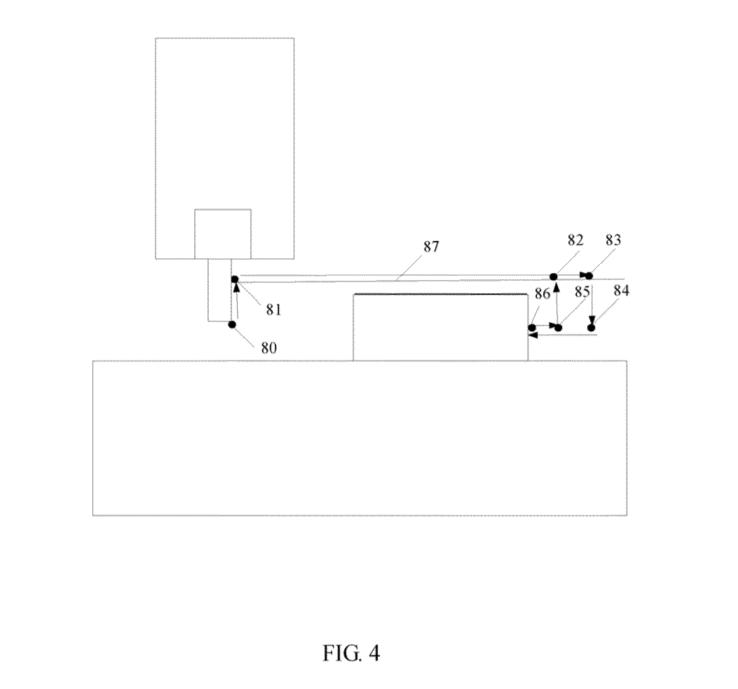

FIG. 4 is a schematic diagram of the probe 22 moving to measure a touch point 86. The probe 22 is vertically lifted by the CNC main spindle 21 from a current point 80 to a first security plane point 81 which is on a security plane 87. The current point 80 indicates a current position of the probe 22. The security plane 87 is a preset plane and parallels to the CNC work table 20. The first security plane point 81 is a projection point of the current point 80 on the security plane 87. After reaching the first security plane point 81, the probe 22 is controlled to move from the first security plane point 81 to a second security plane point 83 at a speed, is decelerated to move from the second security plane point 83 to a close point 84, and then is decelerated to move from the close point 84 to the touch point 86. The speed is larger than a preset speed. The close point 84 approaches the touch point 86. A distance between the close point 84 and the touch point 86 is less than a first preset value (example 2 mm). The second security plane point 83 is a projection point of the close point 84 on the security plane 87. After measuring the touch point 86, the probe 22 rebounds a distance of a second preset value from the touch point 86 to the ricochet point 85, and lastly is moved to a third security plane point 82. The third security plane point 82 is a projection point of the ricochet point 85 on the security plane 87.

FIG. 5 illustrates a flowchart of one embodiment of step S13 of FIG. 3. Depending on the embodiment, additional steps may be added, others removed, and the ordering of the steps may be changed.

In step S130, the measurement module 121 calculates 3D mechanical coordinates of the first security plane point 81 according to 3D mechanical coordinates of the current point 80, and calculates 3D mechanical coordinates of the second security plane point 83 and the close point 84 according to the theory 3D mechanical coordinates of the touch point 26 in the 3D mechanical coordinates system. The 3D mechanical coordinates of the current point 80 are measured by the X-axis optical ruler 25, the Y-axis optical ruler 29 and the Z-axis optical ruler 24.

In step S131, the measurement module 121 controls the probe 22 to move from the current point 80 to the close point 24 according to the 3D mechanical coordinates of the first security plane point 81, the second security plane point 83 and the close point 84. As mentioned above, moving steps of the probe 22 are shown in FIG. 4.

In step S132, the measurement module 121 determines whether a force sensing element of the probe 22 senses the object 28 at the close point 84. The force sensing element is on the head of the probe 22. If the force sensing element of the probe 22 senses the object 28, step S135 is implemented. If the force sensing element of the probe 22 does not sense the object 28, step S133 is implemented, the measuring module 121 controls the probe 22 to move a first preset distance along a negative direction of a normal of a plane of the object 28. The negative direction of the normal points from the close point 84 to the touch point 86. Then step S134 is implemented, the measuring module 121 determines whether the force sensing element of the probe 22 senses the object 28. If the force sensing element of the probe 22 does not sense the object 28, the flow of measuring the touch point 86 is over. If the force sensing element of the probe 22 senses the object 28, the step S135 is implemented.

In step S135, the measurement module 121 controls the probe 22 to reach the touch point 86, and measures the actual 3D mechanical coordinates of the touch point 86 by the X-axis optical ruler 25, the Y-axis optical ruler 29 and the Z-axis optical ruler 24.

In step S136, the measuring module 121 calculates 3D mechanical coordinates of the ricochet point 85 and the third security plane point 82, according to the actual 3D mechanical coordinates of the touch point 86.

In step S137, the measurement module 121 controls the probe 22 to reach the third security plane point 82 from the touch point 86 to the ricochet point 85 and then from the ricochet point 85 to the third security plane point 82, according to the 3D mechanical coordinates of the ricochet point 85 and the third security plane point 82.

FIG. 7 illustrates a flowchart of one embodiment of step S14 of FIG. 3. Depending on the embodiment, additional steps may be added, others removed, and the ordering of the steps may be changed.

In step S140, the creation module 122 fits element types of the object 28 according to actual 3D mechanical coordinates of all the touch points. The element types may include a line, a plane, a circle, an arc, an ellipse, and a sphere. In one embodiment, the creation module 122 uses a method of least squares, in conjunction with the quasi-Newton iterative algorithm, to fit the element types.

In step S141, the creation module 122 determines whether the fit the element types includes a second datum plane. A error between the second datum plane and a preset datum plane is minimum. The preset datum plane is preset by the user according to the object 28. If the fit the element types includes a second datum plane, step S144 is implemented. If the fit the element types does not include a second datum plane, step S142 is implemented, the creation module 122 fits a plane according to three un-collinear touch points. Then step S143 is implemented, the creation module 122 adjusts the plane as the second datum plane. Then goes to step S 144.

In step S144, the creation module 122 projects the fit element types on the second datum plane, and records each projection points.

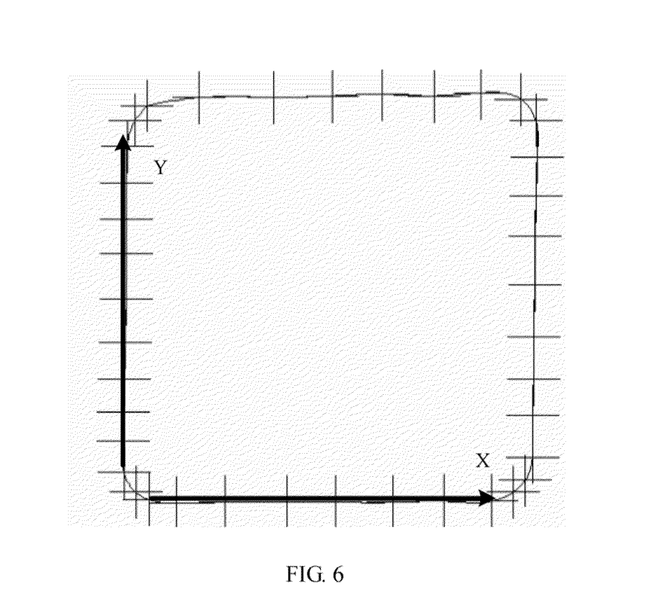

In step S145, the creation module 122 fits two line. The two lines are perpendicular to each other. An intersection of the two lines is regarded as an origin of the 3D workpiece coordinates system. As shown in FIG. 6, one line is as an X-axis of the 3D workpiece coordinates system, the other line is as a Y-axis of the 3D workpiece coordinates system.

In step S146, the creation module 122 fits a Z-axis of the 3D workpiece coordinates system along a normal direction of the second datum plane.

It should be emphasized that the above-described embodiments of the present disclosure, including any particular embodiments, are merely possible examples of implementations, set forth for a clear understanding of the principles of the disclosure.

Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A computerized method being executed by at least one processor of a computing device, the computing device being electronically connected to a computer numerical control (CNC) machine, wherein an object positioned on a worktable of the CNC machine comprises one or more touch points, the method comprising:
controlling a CNC main spindle of the CNC machine to move to a top of a probe, positioned in a module change rack (MCR) of the CNC machine, and to take a probe from the MCR;
touching each touch point on the object by the probe, and measuring actual 3D mechanical coordinates of each touch point in the 3D mechanical coordinates system;
creating a 3D workpiece coordinates system according to the actual 3D mechanical coordinates of all the touch points and element types of the object;
calculating actual 3D workpiece coordinates of all the touch points in the 3D workpiece coordinates system;
calculating deviation values of each touch point between the actual 3D workpiece coordinates of the touch point and theory 3D workpiece coordinates of the touch point;
converting the deviation values of each touch point into mechanical deviation values of the touch point, and compensating the mechanical deviation value of the touch point for the CNC machine.

2. The method according to claim 1, wherein a process of measuring actual 3D mechanical coordinates of each touch point comprises:
calculating 3D mechanical coordinates of a first security plane point according to 3D mechanical coordinates of a current point, and calculating 3D mechanical coordinates of a second security plane point and a close point of the touch point according to theory 3D mechanical coordinates of the touch point in the 3D mechanical coordinates system;
controlling the probe to move from the current point to the close point according to the 3D mechanical coordinates of the first security plane point, the second security plane point and the close point;
when a force sensing element of the probe senses the object at the close point, controlling the probe to reach the touch point, and measuring the actual 3D mechanical coordinates of the touch point;
calculating 3D mechanical coordinates of a ricochet point of the touch point and a third security plane point, according to the actual 3D mechanical coordinates of the touch point;
controlling the probe to reach the third security plane point from the touch point to the ricochet point and from the ricochet point to the third security plane point, according to the 3D mechanical coordinates of the ricochet point and the third security plane point.

3. The method according to claim 2, further comprising:
when the force sensing element of the probe does not sense the object at the close point, controlling the probe to move a first preset distance along a negative direction of a normal of a plane of the object, wherein the negative direction of the normal points is from the close point to the touch point; and
determining whether the force sensing element of the probe senses the object.

4. The method according to claim 1, wherein a process of creating a 3D workpiece coordinates system comprises:
fitting the element types of the object according to actual 3D mechanical coordinates of all the touch points;
when the fit the element types comprises a second datum plane, projecting the fit element types on the second datum plane, and recording each projection points;
fitting two lines and a Z-axis of the 3D workpiece coordinates system along a normal direction of the second datum plane, wherein the two lines are perpendicular to each other, an intersection of the two lines is regarded as an origin of the 3D workpiece coordinates system, one line is as an X-axis of the 3D workpiece coordinates system, the other line is as a Y-axis of the 3D workpiece coordinates system.

5. The method according to claim 4, wherein when the fit element types do not comprise the second datum plane, fitting a plane according to three un-collinear touch points and adjusting the plane as the second datum plane.

6. The method according to claim 1, wherein the element types comprise a line, a plane, a circle, an arc, an ellipse, and a sphere.

7. A computing device, comprising:
a processor; and
a storage device that stores one or more programs, when executed by the at least one processor, cause the at least one processor to perform a probe measurement method, the computing device being electronically connected to a computer numerical control (CNC) machine, wherein an object positioned on a worktable of the CNC machine comprises one or more touch points, the method comprising:
controlling a CNC main spindle of the CNC machine to move to a top of a probe, positioned in a module change rack (MCR) of the CNC machine, and to take a probe from the MCR;
touching each touch point on the object by the probe, and measuring actual 3D mechanical coordinates of each touch point in the 3D mechanical coordinates system;
creating a 3D workpiece coordinates system according to the actual 3D mechanical coordinates of all the touch points and element types of the object;
calculating actual 3D workpiece coordinates of all the touch points in the 3D workpiece coordinates system;
calculating deviation values of each touch point between the actual 3D workpiece coordinates of the touch point and theory 3D workpiece coordinates of the touch point;
converting the deviation values of each touch point into mechanical deviation values of the touch point, and compensating the mechanical deviation value of the touch point for the CNC machine.

8. The computing device according to claim 7, wherein a process of measuring actual 3D mechanical coordinates of each touch point comprises:
calculating 3D mechanical coordinates of a first security plane point according to 3D mechanical coordinates of a current point, and calculating 3D mechanical coordinates of a second security plane point and a close point of the touch point according to theory 3D mechanical coordinates of the touch point in the 3D mechanical coordinates system;
controlling the probe to move from the current point to the close point according to the 3D mechanical coordinates of the first security plane point, the second security plane point and the close point;
when a force sensing element of the probe senses the object at the close point, controlling the probe to reach the touch point, and measuring the actual 3D mechanical coordinates of the touch point;
calculating 3D mechanical coordinates of a ricochet point of the touch point and a third security plane point, according to the actual 3D mechanical coordinates of the touch point;
controlling the probe to reach the third security plane point from the touch point to the ricochet point and from the ricochet point to the third security plane point, according to the 3D mechanical coordinates of the ricochet point and the third security plane point.

9. The computing device according to claim 8, further comprising:
when the force sensing element of the probe does not sense the object at the close point, controlling the probe to move a first preset distance along a negative direction of a normal of a plane of the object, wherein the negative direction of the normal points is from the close point to the touch point; and
determining whether the force sensing element of the probe senses the object

10. The computing device according to claim 7, wherein a process of creating a 3D workpiece coordinates system comprises:
fitting the element types of the object according to actual 3D mechanical coordinates of all the touch points;
when the fit the element types comprises a second datum plane, projecting the fit element types on the second datum plane, and recording each projection points;
fitting two lines and a Z-axis of the 3D workpiece coordinates system along a normal direction of the second datum plane, wherein the two lines are perpendicular to each other, an intersection of the two lines is regarded as an origin of the 3D workpiece coordinates system, one line is as an X-axis of the 3D workpiece coordinates system, the other line is as a Y-axis of the 3D workpiece coordinates system.

11. The computing device according to claim 10, wherein when the fit the element types does not comprise the second datum plane, fitting a plane according to three un-collinear touch points and adjusting the plane as the second datum plane.

12. The computing device according to claim 7, wherein the element types comprises a line, a plane, a circle, an arc, an ellipse, and a sphere.

13. A non-transitory storage medium having stored thereon instructions that, when executed by a processor of an electronic device, causes the processor to perform a probe measurement method in the electronic device, wherein the computing device being electronically connected to a computer numerical control (CNC) machine, an object positioned on a worktable of the CNC machine comprises one or more touch points, the method comprising:
controlling a CNC main spindle of the CNC machine to move to a top of a probe, positioned in a module change rack (MCR) of the CNC machine, and to take a probe from the MCR;
touching each touch point on the object by the probe, and measuring actual 3D mechanical coordinates of each touch point in the 3D mechanical coordinates system;
creating a 3D workpiece coordinates system according to the actual 3D mechanical coordinates of all the touch points and element types of the object;
calculating actual 3D workpiece coordinates of all the touch points in the 3D workpiece coordinates system;
calculating deviation values of each touch point between the actual 3D workpiece coordinates of the touch point and theory 3D workpiece coordinates of the touch point;
converting the deviation values of each touch point into mechanical deviation values of the touch point, and compensating the mechanical deviation value of the touch point for the CNC machine.

14. The non-transitory storage medium according to claim 13, wherein a process of measuring actual 3D mechanical coordinates of each touch point comprises:
calculating 3D mechanical coordinates of a first security plane point according to 3D mechanical coordinates of a current point, and calculating 3D mechanical coordinates of a second security plane point and a close point of the touch point according to theory 3D mechanical coordinates of the touch point in the 3D mechanical coordinates system;
controlling the probe to move from the current point to the close point according to the 3D mechanical coordinates of the first security plane point, the second security plane point and the close point;
when a force sensing element of the probe senses the object at the close point, controlling the probe to reach the touch point, and measuring the actual 3D mechanical coordinates of the touch point;
calculating 3D mechanical coordinates of a ricochet point of the touch point and a third security plane point, according to the actual 3D mechanical coordinates of the touch point;
controlling the probe to reach the third security plane point from the touch point to the ricochet point and from the ricochet point to the third security plane point, according to the 3D mechanical coordinates of the ricochet point and the third security plane point.

15. The non-transitory storage medium according to claim 14, further comprising:
when the force sensing element of the probe does not sense the object at the close point, controlling the probe to move a first preset distance along a negative direction of a normal of a plane of the object, wherein the negative direction of the normal points is from the close point to the touch point; and
determining whether the force sensing element of the probe senses the object

16. The non-transitory storage medium according to claim 13, wherein a process of creating a 3D workpiece coordinates system comprises:
fitting the element types of the object according to actual 3D mechanical coordinates of all the touch points;
when the fit the element types comprises a second datum plane, projecting the fit element types on the second datum plane, and recording each projection points;
fitting two lines and a Z-axis of the 3D workpiece coordinates system along a normal direction of the second datum plane, wherein the two lines are perpendicular to each other, an intersection of the two lines is regarded as an origin of the 3D workpiece coordinates system, one line is as an X-axis of the 3D workpiece coordinates system, the other line is as a Y-axis of the 3D workpiece coordinates system.

17. The computing device according to claim 16, wherein when the fit the element types does not comprise the second datum plane, fitting a plane according to three un-collinear touch points and adjusting the plane as the second datum plane.

18. The computing device according to claim 13, wherein the element types comprises a line, a plane, a circle, an arc, an ellipse, and a sphere.
